(19) United States
(12) Patent Application Publication
(10) Pub. No.: US 2007/0069174 A1
(43) Pub. Date: Mar. 29, 2007

(54) Composite and susceptor for semiconductor manufacturing device and power module with the same

(75) Inventors: Masuhiro Natsuhara, Itami-shi (JP); Hirohiko Nakata, Itami-shi (JP); Tomoyuki Awazu, Itami-shi (JP); Akira Mikumo, Itami-shi (JP)

Correspondence Address: GLOBAL IP COUNSELORS, LLP, 1233 20TH STREET, NW, SUITE 700, WASHINGTON, DC, 20036-2680, US

(73) Assignee: Sumitomo Electric Industries, Ltd., Osaka-shi (JP)

(21) Appl. No.: 11/509,822

(22) Filed: Aug. 25, 2006

(30) Foreign Application Priority Data
Sep. 27, 2005 (JP) 2005-278989

(51) Int. Cl. H01F 1/04; C01G 49/08; B22F 3/00; C04B 35/64; C04B 35/26; H01F 1/14

(52) U.S. Cl. 252/62.55; 252/62.56

(57) ABSTRACT

The present invention provides a composite having superior reliability and superior binding strength with respect to films formed on substrates by aerosol methods, and also provides a semiconductor manufacturing devices susceptor and a power module substrate. In the composite of the present invention, a film formed by an aerosol method is provided on a surface of a composite formed from a plurality of metals. Alternatively, a film formed by an aerosol method may be provided on the surface of a composite formed from a metal and a ceramic. The composite preferably has a thermal conductivity of 100 W/mK or greater, and the film formed by the aerosol method preferably has a thermal conductivity of 1 W/mK or greater.

### TECHNICAL FIELD

The present invention relates to a composite formed from a plurality of metals, or a composite of ceramic and metal, having a film formed on its surface by an aerosol method, which is desirable for use in susceptors for semiconductor manufacturing device or power module substrates.

### BACKGROUND ART

In the past, various types of power modules with mounted elements such as semiconductor elements, light receiving and emitting elements, and passive elements have been studied. For example, a circuit substrate is disclosed in Japanese Laid-Open Patent Application Publication No. 2004-342831 in which dielectric films, resistor films, and semiconductor films are formed by aerosol methods on substrates. This publication discloses the use of ceramics, resins, and alloys comprising Fe, Ni, Mo, W, Al, Cu, Ag, Au, and the like as base substrates, and also discloses the use of Al₂O₃ or TiO₂ as dielectric films. However, the binding strength of base substrates and films formed by aerosol methods is susceptible to the influence of thermal cycling, and there have been problems with loss of reliability due to peeling and the like.

Moreover, Japanese Laid-Open Patent Application Publication No. 2005-109234 discloses the use of semiconductor manufacturing members produced by forming an insulating layer on the surface of a semiconductor substrate, and the potential for use thereof as an electrostatic chuck. In this method, an insulating layer is formed on a substrate, an additional electrode is formed on this insulating layer by a technique such as thin film formation, and an additional insulating layer is also formed. However, films that withstand thermal cycling have not been obtained by this technique, and there have thus been problems with restricted applications.

### DISCLOSURE OF INVENTION

The present invention was developed in order to resolve the above problems. Specifically, an object of the present invention is to provide a composite that has superior reliability resulting from superior binding of films formed by aerosol methods on substrates, a susceptor for semiconductor manufacturing device, and a power module substrate.

The composite of the present invention has a film formed by an aerosol method on the surface of a composite substrate formed from a plurality of metals. Alternatively, the composite substrate may have a film formed by an aerosol method on the surface of a composite formed from a metal and a ceramic.

The thermal conductivity of the composite substrate is preferably 100 W/mK or greater, and the thermal conductivity of the film formed by the aerosol method is preferably 1 W/mK or greater.

The main components of the composite substrate are preferably selected from copper and tungsten (Cu—W), copper and molybdenum (Cu—Mo), aluminum and silicon carbide (Al—SiC), silicon and silicon carbide (Si—SiC), and aluminum and aluminum nitride (Al—AlN), and the primary component of the film formed by the above aerosol method is selected from aluminum nitride (AlN), aluminum oxide (Al₂O₃), silicon nitride (Si₃N₄), silicon oxide (SiO₂), and yttrium oxide (Y₂O₃).

A conductive film is also formed on the film formed by the aerosol method, the conductive film is preferably patterned, and the film is preferably formed by an aerosol method.

The composite of the present invention is preferably used in susceptors for semiconductor manufacturing device or power module substrates.

The present invention can provide a composite with superior reliability because the film is formed by an aerosol method on a metal composite substrate or metal-ceramic composite substrate.

### BEST MODE FOR CARRYING OUT THE INVENTION

The composite of the present invention is a composite that has a film formed by an aerosol method on the surface of a composite substrate of a plurality of metals or of metal and ceramic. Normally, film formation is carried out at normal temperatures when, for example, copper or aluminum is the metal used as the substrate, and a film such as alumina, AlN, or SiO₂ is formed on the surface of the metal by an aerosol method. Consequently, film formation can be readily performed. However, when substrates with films formed thereon have been used as components that are subjected to thermal cycling, there have been cases where peeling of the film from the substrate has occurred due to the significant difference in thermal expansion coefficient between the copper or aluminum and a film such as alumina, AlN, or SiO₂.

In the present invention, the substrate is a composite of a plurality of metals or of metal and ceramic, and thus the thermal expansion coefficients of the substrate and film can be made to match one another. For this reason, peeling of the film can be prevented when the film is used in composites that are subjected to thermal cycling.

The composite of a plurality of metals that is used as a substrate is preferably a combination of metal materials used in order to match the thermal expansion coefficient of the film to be formed, and metal materials used in order to ensure favorable binding strength with the film formed by an aerosol method. The metal materials for ensuring favorable binding strength are preferably soft metals.

The film that is formed by an aerosol method is deposited so that the film material impacts the substrate surface, and thus binds to the substrate by virtue of an anchoring effect. Using a soft material for the substrate causes the film material to penetrate farther into the substrate, thereby increasing the anchoring effect and heightening the binding strength of the film. Examples of soft metals that may be cited include copper or aluminum, nickel, gold, silver, and silicon. However, excluding silicon, these materials have comparatively high coefficients of thermal expansion, and thus the films tend to peel with thermal cycling when ceramic films with comparatively small coefficients of thermal expansion are formed.

In order to resolve this problem, binding strength with films formed by aerosol methods can be ensured when the substrate is a composite formed from ceramic or metal with comparatively low coefficient of thermal expansion, and a soft metal. Because the coefficient of thermal expansion of the substrate thus matches the thermal expansion of the film formed by an aerosol method, problems such as peeling resulting from thermal cycling can be diminished.

Well-known methods can be used as the composite substrate production method of the present invention. For example, a ceramic or a metal porous body with comparatively low coefficient of thermal expansion may be used as a base, and this porous base may be impregnated by a method such as infusion or the like using the above soft metals. Examples of ceramics or metals with low coefficients of thermal expansion include tungsten, molybdenum, silicon carbide, aluminum nitride, and alumina. These materials are comparatively hard materials, and thus have binding strengths that are inferior in comparison to he above types of soft metals, even when a ceramic film is formed using an aerosol method. However these materials have coefficients of thermal expansion that are fairly close to those of the film materials of alumina, AlN, or SiO₂, and thus peeling of films due to thermal cycling tends not to occur.

Consequently, binding strength with respect to films formed by aerosol methods is ensured when composites substrate are used that are produced by combining metals or ceramics having low coefficients of thermal expansion and soft metal materials such as copper, aluminum, nickel, gold, silver, or silicon. In addition, a composite can be obtained that has superior reliability and does not have problems with loss of binding strength or peeling of films due to thermal cycling.

Aerosol methods involve the use of aerosol generators that convert microparticulate materials for film formation into aerosols, and filming chambers in which the aerosolized microparticulate film material is sprayed to form a film on a substrate. A gas tank for supplying high-pressure argon or the like as carrier gas, and mass controller lines are connected to the aerosol generator. If the material used for film formation is an oxide such as alumina or SiO₂, an oxidative gas such as air may be used as the carrier gas. It is preferable to provide the aerosol generator with a vibration device whereby microparticle aggregates are broken down by ultrasonic vibration, electromagnetic vibration, or mechanical vibration, thereby producing primary particles. This is because favorable anchoring effects with respect to the substrate material are difficult to obtain when the particles undergo aggregation during film formation.

It is preferable for the particle diameter of the material used as the film material to be 1 μm or less. If the particles exceed 1 μm, sufficient anchoring effects with respect to the substrate material will not be obtained, even if the powder impacts the substrate. In addition, it is preferable for the microparticle spray velocity to be 500 m/s or less. If the spray velocity exceeds this level, there is the danger that the substrate will be damaged during film formation. It is preferable for the spray velocity to be 3 m/s or greater, because sufficient anchoring effects will not be obtained at lower velocities. Moreover, it is normally necessary for the surface of the substrate for film formation to be clean, because sufficient anchoring effects will not be obtained if oil or other contaminants are present when the micropowder impacts the substrate.

The thermal conductivity of the composite substrate is preferably 100 W/mK or greater. With lower thermal conductivities, it will be difficult to manifest sufficient thermal radiation effects when the composite is used as a power module substrate. The difficulty is due to the increased amounts of heat that are produced by the currently used semiconductor chips. In addition, when the material is used as a susceptor for semiconductor manufacturing device, it will be difficult to obtain sufficient thermal soaking in cases where such soaking of the susceptor wafer-carrying surface is required. For this reason, specific examples of materials for the composite substrate pertaining to the present invention include Al—SiC as a composite of aluminum and silicon carbide, Si—SiC as a composite of silicon and silicon carbide, Al—AlN as a composite of aluminum and aluminum nitride, and Cu—W or Cu—Mo as a composite of copper with tungsten or molybdenum. These materials are preferred because they all have high thermal conductivities, as well as comparatively high thermal conductivities when used in combinations.

There are no particular restrictions on the film material that is formed on the composite substrate, but when the application is a power module substrate, high thermal conductivities are preferred, and 1 W/mK or greater is particularly preferred. Examples of film materials that may be cited include aluminum nitride (AlN), aluminum oxide (Al₂O₃), silicon nitride (Si₃N₄), silicon oxide (SiO₂), and yttrium oxide (Y₂O₃). These materials have comparatively high thermal conductivities, and are thus desirable because of their superior thermal conductivity when used in power module substrates. Moreover, high thermal conductivities are preferred because of the importance of ensuring thermal soaking of the wafer-carrying surface in susceptors for semiconductor manufacturing device, and thus the same materials as above may be cited. Moreover, when the material is to be used as a susceptor for semiconductor manufacturing device, there are cases where resistance to corrosion by the atmosphere that is to be used is desired. In this case, it is preferable to use a rare earth oxide such as Y₂O₃ as the film material.

In addition, when a power module substrate is to be produced, an insulating film is formed on the composite substrate of multiple metals or of metal and ceramic. A conductor film may subsequently be formed on the insulating film. This conductor film may be used for soldering or brazing components or the like, and may also be a wiring pattern. In particular, when used as a power module substrate, it is preferable for the film to have a wiring pattern that transmits electrical signals or the like to the elements that are to be cooled.

When a susceptor for semiconductor manufacturing device is to be produced, the film composed of such a material is formed at the prescribed thickness on the composite substrate that is used. For example, an alumina film is formed by an aerosol method on the composite substrate, and then a circuit pattern of an exothermic body or the like is formed by various methods, including an aerosol method. In general, alumina has superior wetting properties relative to metals, and thus can ensure favorable binding to the circuit pattern. Moreover, alumina is formed as a circuit pattern overcoat layer by an aerosol method. Thus, if a film of Y₂O₃ is formed thereupon, a susceptor for semiconductor manufacturing device can be produced that has excellent reliability due to superior corrosion resistance, circuit pattern binding, and the like.

There are no particular restrictions on the method for forming the conductor film after forming an insulating film on the composite substrate as described above, and methods can be selected from vapor deposition methods, sputtering, CVD, or other thin film formation methods, as well as screen printing or other thick film formation methods. In addition, the conductor film may be formed by an aerosol method. When film formation is carried out using, for example, an aerosol method, patterning is carried out using a photosensitive resin on the substrate on which the film is to be formed, and a conductor film is then formed over the regions where the film is to be formed. Subsequently, pattern formation can be carried out by stripping the resin. There are no particular restrictions on the film to be used as a conductor in such cases, and copper, aluminum, nickel, gold, silver, or the like may be used. It is also possible to produce a multilayer structure by forming an insulating film over the conductor film by an aerosol method. If the insulating layers and conductor layers are both formed using aerosol methods in this manner, then it is possible to carry out all the film formation steps in a single apparatus, thereby allowing comparatively inexpensive production of the power module substrate or susceptor for semiconductor manufacturing device.

The power module substrate, or the susceptor substrate for a semiconductor manufacturing device produced in this manner has superior binding power with respect to films formed on the substrate, while also having superior reliability in regard to thermal cycling or the like.

### WORKING EXAMPLE 1

A substrate having a thickness of 3 mm was prepared using the 50 mm×50 mm materials indicated in Table 1, and films of the various materials shown in Table 1 were formed at thicknesses of 0.05 mm by an aerosol method. The average particle diameters of the substances were all 0.1 μm or less, and the spray velocity was set to 200 m/s. Thermal cycle testing was carried out for 20 cycles by increasing the temperature of the prepared substrates from −70° C. to +150° C., and the condition of the films was observed. The results are shown in Table 1. The condition of the films was classified in the following manner: ◯ indicated lack of peeling and maintenance of strong binding force; Δ indicated no peeling, but some peeling in the cross-hatch test; and × indicated partial peeling of the film.

TABLE 1

| | | Substrate | | |
|---|---|---|---|---|
| | Substrate | thermal | | |
| | thermal | expansion | | Film condition |
| Substrate | conductivity | coefficient | Film | following heat |
| material | (W/mK) | (×10⁻⁶/K) | material | cycle test |
| Al—SiC | 150 | 14 | Alumina | ∘ |
| Al—SiC | 150 | 14 | Si₃N₄ | ∘ |
| Al—SiC | 150 | 14 | AlN | ∘ |
| Al—SiC | 150 | 14 | SiO₂ | ∘ |
| Al—SiC | 150 | 14 | Y₂O₃ | ∘ |
| Si—SiC | 180 | 3 | Alumina | ∘ |
| Si—SiC | 180 | 3 | Si₃N₄ | ∘ |
| Si—SiC | 180 | 3 | AlN | ∘ |
| Si—SiC | 180 | 3 | SiO₂ | ∘ |
| Si—SiC | 180 | 3 | Y₂O₃ | ∘ |
| Al—Al₂O₃ | 60 | 12 | Alumina | ∘ |
| Al—Al₂O₃ | 60 | 12 | Si₃N₄ | ∘ |
| Al—Al₂O₃ | 60 | 12 | AlN | ∘ |
| Al—Al₂O₃ | 60 | 12 | SiO₂ | ∘ |
| Al—Al₂O₃ | 60 | 12 | Y₂O₃ | ∘ |
| Cu—W | 200 | 8 | Alumina | ∘ |
| Cu—W | 200 | 8 | Si₃N₄ | ∘ |
| Cu—W | 200 | 8 | AlN | ∘ |
| Cu—W | 200 | 8 | SiO₂ | ∘ |
| Cu—W | 200 | 8 | Y₂O₃ | ∘ |
| Cu—Mo | 160 | 8 | Alumina | ∘ |
| Cu—Mo | 160 | 8 | Si₃N₄ | ∘ |
| Cu—Mo | 160 | 8 | AlN | ∘ |
| Cu—Mo | 160 | 8 | SiO₂ | ∘ |
| Cu—Mo | 160 | 8 | Y₂O₃ | ∘ |
| Al—W | 100 | 13 | Alumina | ∘ |
| Al—W | 100 | 13 | Si₃N₄ | ∘ |
| Al—W | 100 | 13 | AlN | ∘ |
| Al—W | 100 | 13 | SiO₂ | ∘ |
| Al—W | 100 | 13 | Y₂O₃ | ∘ |
| Cu | 400 | 17 | Alumina | Δ |
| Cu | 400 | 17 | Si₃N₄ | x |
| Cu | 400 | 17 | AlN | x |
| Cu | 400 | 17 | SiO₂ | x |
| Cu | 400 | 17 | Y₂O₃ | x |
| Al | 220 | 23 | Alumina | x |
| Al | 220 | 23 | Si₃N₄ | x |
| Al | 220 | 23 | AlN | x |
| Al | 220 | 23 | SiO₂ | x |
| Al | 220 | 23 | Y₂O₃ | x |

It is to be concluded from the above that markedly superior thermal cycling characteristics as well as extremely favorable film binding are produced when films are formed by aerosol methods on composite substrates of metals and composite substrates of metal and ceramic.

### WORKING EXAMPLE 2

In the same manner as in Working Example 1, alumina films were laminated at 0.05 mm by an aerosol method on the substrates shown in Table 2, 2-μm nickel layers were laminated thereon by an aerosol method, and semiconductor chips measuring 10 mm on a side were soldered thereto. The semiconductor chips were made to emit heat, and the cooling performance of the composites was compared. The results are shown in Table 2. Cases where the semiconductor chip operated normally are indicated by ◯, and cases where the semiconductor chip was damaged due to heat are indicated by ×.

TABLE 2

| | Substrate | | |
|---|---|---|---|
| | thermal | Substrate thermal | |
| Substrate | conductivity | expansion coefficient | Semiconductor |
| material | (W/mK) | (×10⁻⁶/K) | chip condition |
| Al—SiC | 150 | 14 | ∘ |
| Si—SiC | 180 | 3 | ∘ |
| Cu—W | 200 | 8 | ∘ |
| Cu—Mo | 160 | 8 | ∘ |
| Al—W | 100 | 13 | ∘ |
| Al—Al₂O₃ | 60 | 12 | x |

From the above, it is concluded that the thermal conductivity of the substrate is preferably 100 W/mK or greater when the composite of the present invention is used as a heat sink.

### WORKING EXAMPLE 3

In the same manner as in Working Example 2, films of the materials indicated in Table 3 were laminated to Si—SiC substrates at 0.05 mm by an aerosol method, 2-μm nickel films were laminated thereon by an aerosol method, and semiconductor chips measuring 10 mm on a side were soldered thereto. The semiconductor chips were made to emit heat, and the cooling performance of the composites was compared. The results are shown in Table 2. Cases where the semiconductor chip operated normally are indicated by ◯, and cases where the semiconductor chip was damaged due to heat are indicated by ×.

TABLE 3

| | Thermal | |
|---|---|---|
| Film | conductivity | Semiconductor |
| material | (W/mK) | chip condition |
| AlN | 80 | ∘ |
| Alumina | 20 | ∘ |
| SiO₂ | 1 | ∘ |
| Si₃N₄ | 20 | ∘ |
| Y₂O₃ | 2 | ∘ |
| Polyimide | 0.3 | x |

From the above, it is concluded that the thermal conductivity of the film is preferably 1 W/mK or greater when the composite of the present invention is used as a heat sink.

### WORKING EXAMPLE 4

A 0.05 mm AlN film was laminated over the entire surface of a substrate by using a Cu—W substrate from among the substrates of Working Example 1. The entire surface was then coated with a resist film, exposed, and developed to form a circuit pattern. Copper was then formed at a thickness of 5 μm thereupon, thus forming a circuit pattern. The unwanted resist film was then stripped, and the regions for connecting with an external power source and a semiconductor chip were coated with a resist film in the same manner as above. An AlN film was then formed at 0.05 mm by an aerosol method. The resist film was then removed, and a semiconductor chip measuring 10 mm on a side was soldered thereupon, connecting the circuits. The semiconductor chip was then operated continuously for 10 hours. The semiconductor element adequately radiated heat, and was able to function continually without problems.

### WORKING EXAMPLE 5

A composite was produced in the same manner as in Working Example 4, with the exception that aluminum was used for the circuit pattern material. Semiconductor chip evaluation was carried out in the same manner as in Working Example 4. The semiconductor element adequately radiated heat, and was able to function continually without problems.

### WORKING EXAMPLE 6

An alumina film was formed at thickness of 0.03 mm by an aerosol method on one surface of an Al—SiC composite substrate having a thickness of 10 mm and a diameter of 330 mm. Next, a resist film was formed on the surface on which the film had been formed, and exposure and development were carried out to produce an exothermic body pattern. Next, Ni—Cr alloy microparticles were formed as an exothermic body thereupon at a thickness of 10 μm by an aerosol method, and the resist film was stripped to produce the exothermic body. An alumina film was then formed at a thickness of 0.03 mm by an aerosol method over the entire surface on which the exothermic body had been formed. The resulting heater was then used as to cure semiconductor resist films. The heater was used for 100 cycles under heating conditions that varied from room temperature to 200° C. No film peeling occurred, and a highly reliable susceptor was obtained.

### WORKING EXAMPLE 7

An AlN film having a thickness of 10 mm and a diameter of 330 mm was formed on an Si—SiC substrate at a thickness of 0.03 μm by an aerosol method. A resist film was applied thereupon, and exposure and development were carried out to produce an exothermic body pattern. Next, a resist pattern having a diameter of 300 mm was formed as a high-frequency generating electrode on the opposite surface. A W film was then formed at a thickness of 10 μm by an aerosol method on both surfaces of the substrate on which the pattern had been formed, the resist film was removed, and a 30-μm AlN film was then formed on both surfaces. The device was then used as a susceptor for forming wafer CVD films. Film peeling did not occur despite the fact that the device was used for 100 hours in an environment that ranged from room temperature to 540° C.

### WORKING EXAMPLE 8

A susceptor was produced in the same manner as in Working Example 7. A Y₂O₃ film having a thickness of 10 μm was then formed on both surfaces of the resulting susceptor. This device was then subjected to corrosion resistance testing in CF₄ corrosive gas at 540° C. In addition, corrosion testing was carried out under the same conditions for the susceptor produced in Working Example 7. The results demonstrate that devives produced by forming Y₂O₃ films have half the CF₄ etching rate.

### INDUSTRIAL APPLICABILITY

By means of the present invention, films can be formed by aerosol methods on composite substrates of metal or composite substrates of metal and ceramic, thus providing composites having superior reliability. The composites of the present invention can be used as corrosion-resistant and highly reliable susceptors for semiconductor manufacturing device and power module substrates having high cooling capacity.

1. A composite comprising:
a composite substrate formed from a plurality of metals; and
a film formed by an aerosol method on a surface of the composite material.

2. A composite comprising
a composite substrate formed from a metal and a ceramic; and
a film formed by an aerosol method on a surface of the composite material.

3. The composite according to claim 1, wherein
the composite substrate has a thermal conductivity of 100 W/mK or greater.

4. The composite according to claim 2, wherein
the composite substrate has a thermal conductivity of 100 W/mK or greater.

5. The composite according to claim 1, wherein
the film has a thermal conductivity of 1 W/mK or greater.

6. The composite according to claim 2, wherein
the film has a thermal conductivity of 1 W/mK or greater.

7. The composite according to claim 1, wherein
the composite substrate is one of a composite of copper and tungsten, and a composite of copper and molybdenum.

8. The composite according to claim 2, wherein
the composite substrate is one of a composite of aluminum and silicon carbide, a composite of silicon and silicon carbide, and a composite of aluminum and aluminum nitride.

9. The composite according to claim 1, wherein
the film includes one of aluminum nitride, (AlN), aluminum oxide (Al₂O₃), silicon nitride (Si₃N₄), silicon oxide (SiO₂), and yttrium oxide (Y₂O₃) as a primary component.

10. The composite according to claim 2, wherein
the film includes one of aluminum nitride, (AlN), aluminum oxide (Al₂O₃), silicon nitride (Si₃N₄), silicon oxide (SiO₂), and yttrium oxide (Y₂O₃) as a primary component.

11. The composite according to claim 1, further comprising
a conductive film formed on the film formed by the aerosol method.

12. The composite according to claim 2, further comprising
a conductive film formed on the film formed by the aerosol method.

13. The composite according to claim 11 wherein
the conductive film is patterned.

14. The composite according to claim 12, wherein
the conductive film is patterned.

15. The composite according to claim 11, wherein
the conductive film is formed by the aerosol method.

16. The composite according to claim 12, wherein
the conductive film is formed by the aerosol method.

17. A susceptor for semiconductor manufacturing device comprising the composite according to claim 1.

18. A susceptor for semiconductor manufacturing device comprising the composite according to claim 2.

19. A power module comprising the composite according to claim 1.

20. A power module comprising the composite according to claim 2.
